(19) United States
(12) Patent Application Publication
(10) Pub. No.: US 2003/0115076 A1
(43) Pub. Date: Jun. 19, 2003

(54) Method and apparatus for delivering building safety information

(76) Inventors: Hector Manuel Gomez, Pasadena, CA (US); Ramon Diaz, Pasadena, CA (US)

Correspondence Address: Hector Gomez, 556 South Fair Oaks, Suite 180, Pasadena, CA, 91105, US

(21) Appl. No.: 10/097,783

(22) Filed: Mar. 13, 2002

Related U.S. Application Data
(60) Provisional application No. 60/341,352, filed on Dec. 15, 2001.

(51) Int. Cl. G06F 17/60

(52) U.S. Cl. 705/1

(57) ABSTRACT

An online, interactive emergency response training system designed to facilitate the dissemination of safety preparedness information for natural and man-made emergencies, including, but not limited to: fire, earthquake, bomb, medical, and power failure is hereby disclosed. Additionally, various other methods of disseminating said safety preparedness information are also disclosed.

### PRIORITY

The application claims priority to U.S. provisional application No. 60/341,352, filed on Dec. 15, 2001.

### DESCRIPTION

1. Scope of the Invention

A method of automating and personalizing the delivery of property-specific building safety information to occupants of commercial buildings.

2. Background of the Invention

In today's commercial real estate market, many buildings share common management whether commonly owned or not. In certain circumstances, a building owner, particularly one with fewer properties, may determine that it is more advantageous Method And Apparatus For Delivering Building Safety Information to hire a third-party management company than to manage the properties in-house. This often produces greater managerial efficiency in that a single large management company can deploy building managerial services more efficiently across a large number of properties than can a building owner with few properties. These services may include, advertising, prospective tenant screening, maintenance, janitorial services, etc. Consequently, many commercial buildings, particularly hi-rise, Class A, Class B, and Class C buildings, are wholly managed by a third-party management company. It is not unusual for larger management companies to manage hundreds if not thousands of buildings nationwide.

Alternatively, it is not uncommon for a building owner with many properties to choose to create its own management company to manage only its buildings. Oftentimes, these building owners are institutional investors and real estate investment trusts (REITs). These owners may have sufficient properties to enjoy the same economies of scale that a large third-party management company has.

The main purpose of property management is to manage the day-to-day aspects of the property in such a manner that will minimize occupant turnover and maximize occupancy rates. In order to ensure maximum occupancy rates, property management must be responsive to the needs of the tenant, including the timely and efficient operations of parking, climate control, building access, electrical, plumbing, security, and safety systems. As a practical matter, many of these services are outsourced to minimize overhead and to take advantage of the economies of scale inherent in a shared resource.

One of the services that property management provides directly or through subcontracting is building safety information and training. In every major metropolitan area within the United States, commercial buildings are subject to safety codes imposed by federal, state, and local governments. These safety codes are intended to protect the health, safety, and general welfare of the American people. Each lower level of government adds safety requirements that reflect the unique and often incompatible safety concerns of the geographic locale. For example, communities in the southeast U.S. might be particularly concerned with hurricanes, yet hurricanes are almost non-existent on the West Coast.

Presently, most municipalities require that each occupant of a commercial building receive safety training regarding the emergency procedures in place to deal with a variety of situations such as fire and earthquake. This responsibility may fall on either the tenant, the building manager, the building owner, or any combination thereof.

Certain factors make it particularly difficult for owners and management companies to comply with safety training requirements, including:

The uniqueness of each building

The ongoing training requirement

The diversity of safety codes with which to comply

One of the biggest problems for a large management company is the uniqueness of each building. Their business model is predicated upon being able to provide the nearly undifferentiated service to numerous clients, therefore maximizing their economies of scale. Yet safety training, by definition, must be tailored to each building to be effective. Additionally, even should buildings be identical, those located in different areas will often mean different safety codes with which to comply.

Finally, once the compliance program is implemented, each occupant within the building must be trained on a timely basis. On the emergency response procedures. However, a Hi rise may have a multitude of tenants, each with a revolving door of employees or occupants. Not only must each occupant be trained, but a record of the training should be preserved for auditing and compliance purposes.

Various business entities have attempted to solve this issue with varying successes. However, this field is an emerging market with no dominant player. Most participants are usually providers of other commercial services such as building security and perform building emergency response planning training as an ancillary service for their clients.

However, the consequence of the current business model is that many businesses do not fully comply with the safety rules, specifically, those instructions that are nominally tailored to a particular building. The delivery is haphazard, and oftentimes the local municipalities find numerous violations upon audit.

In addition, property owners and managers almost always carry property casualty insurance and general liability insurance on their properties. These premiums tend to be expensive due to high property replacement value and potential for various personal injuries. Insurance companies have long given premium reductions when its insured can demonstrate that its likelihood of losses can be mitigated through preparedness or preventative measures. Some common examples include health insurance reductions for non-smokers and car insurance premium reductions for anti-theft devices.

### SUMMARY OF THE INVENTION

The invention described herein represents and exemplary system for assisting in the mitigation of losses, both human and financial, by educating and training the occupants of commercial buildings to be prepared for earthquakes, fires, medical emergencies, power failures, etc. thereby enhancing the probability of reducing the number of fatal and non-fatal injuries in commercial buildings. This reduction in the building's risk profile should qualify the building for an insurance premium reduction.

### BRIEF DESCRIPTION OF THE DRAWINGS

FIG. 1 represents a flow diagram of the preferred embodiment of this invention.

FIG. 2 represents a flow diagram of the preferred embodiment of this invention.

FIG. 3 represents a flow diagram of the preferred embodiment of this invention.

FIG. 4 represents a flow diagram of the preferred embodiment of this invention.

FIG. 5 represents a flow diagram of the preferred embodiment of this invention.

FIG. 6 represents a flow diagram of the preferred embodiment of this invention.

FIG. 7 represents a flow diagram of the preferred embodiment of this invention.

FIG. 8 represents a flow diagram of the preferred embodiment of this invention.

### DETAILED DESCRIPTION

The invention disclosed herein relates to an exemplary method and apparatus for automated delivery of personalized building safety solutions in a timely manner to all occupants of commercial buildings.

The invention consists of the following steps:

Identification of buildings that would benefit from the delivery of said information;

Obtaining building-specific fire and life safety systems information from the appropriate persons;

Developing a customized emergency response plan for the occupants of each building;

Creating a customized multi-media presentation unique to each building.

Delivering the content to the occupants of the buildings;

Provide interactive testing of material in presentation; and

Retain results of the interactive session for accounting, legal, human resources, and risk management compliance.

There are thousands upon thousands of commercial buildings in the United States. However, only a certain type of commercial building is likely to benefit from the invention herein. In the preferred embodiment of the invention, and without limitation to other embodiments, the hi rise, Class A, Class B, and Class C buildings, that are managed by a large management companies are the most likely to benefit from this invention. These buildings are most likely to be found in downtown or central business districts of major metropolitan areas. In another preferred embodiment of the invention, the buildings should have the latest telecommunications, to wit: some form of broadband connectivity.

Once a building has been selected, the safety specifications are obtained from any authorized person such as the property manager, building or safety engineer, fire marshal, etc.

The content is created using an interactive multi-media presentation that would include all of the relevant emergency response procedures including earthquake, fire, medical emergencies, power failures, etc. In the preferred embodiment, the presentation would be interactive, including functionality for VCR-type controls, hypertext links, etc. This content production is unique to each building.

In the preferred embodiment, the content is delivered via the Internet using broadband access, which would permit a multi-media presentation. In a further embodiments, the presentation could reside on the user's server.

In another embodiment of the invention, and without limitation to other embodiments, the presentation is provided to the user on mass storage devices including, but not limited to, CD-Rom, DVD-Rom, and zip disk.

In yet another embodiment of the invention, the presentation is provided to the user via audio-visual equipment, including, but not limited to, video cassettes and DVD.

Testing would be conducted using the same manner as deployment. In the preferred embodiment of the invention, testing would be interactive wherein after the presentations, the user would take the safety test online. Incorrect answers would cause a replay of selected portions of the presentation and the question repeated until a correct answer was provided. This replay could occur either manually or automatically.

In another embodiment, testing would be accomplished through a telephone response system where the user would select the answer to a multiple-choice question using the telephones numeric keypad.

The invention would include a standard password and user Id authentication system.

In the preferred embodiment of the invention, revenue is achieved through any combination of the following: Creating the safety presentation, maintaining the presentation, updating the presentation as necessary, the usage of the system, and record keeping.

### DESCRIPTION OF THE SPECIFIC EMBODIMENTS

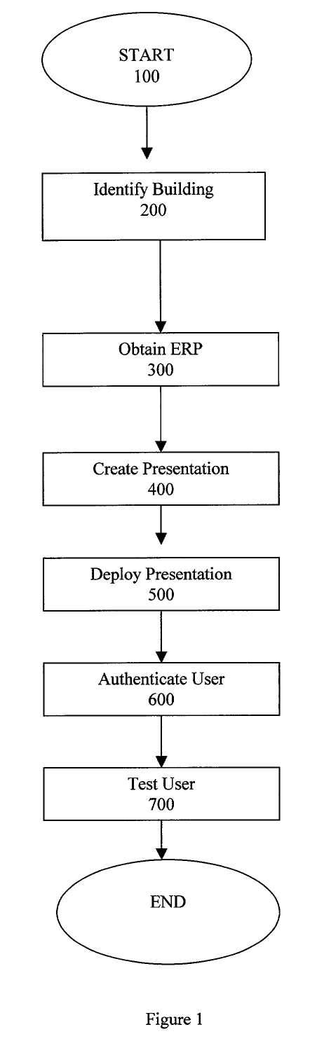

Referring to FIG. 1, the system starts at step 100. At step 200, an appropriate building for the system is identified. At step 300 the system obtains an emergency response plan. At step 400 the system creates a customized presentation utilizing the emergency response plans. At step 500 the presentation is deployed to the user. At step 600 the system authenticates the user to determine the appropriate presentation to execute. At step 700, the presentation is executed, the user tested, the results stored, and the test results tabulated.

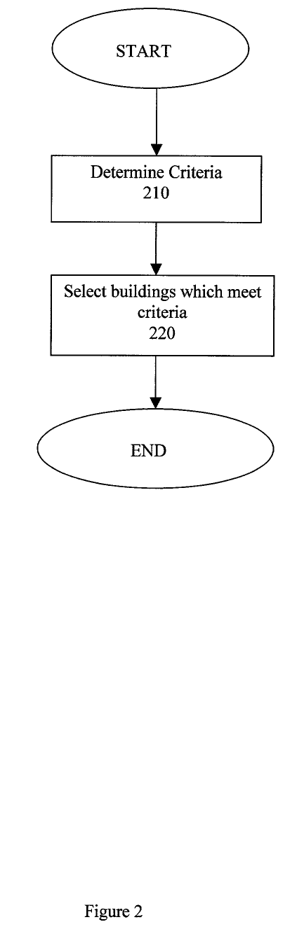

Referring to FIG. 2, at step 210 the system selects a set of criteria which determines the several classes of properties whose occupants would benefit from the system. At step 220 properties and the system criteria are matched to select potential buildings to deploy the system.

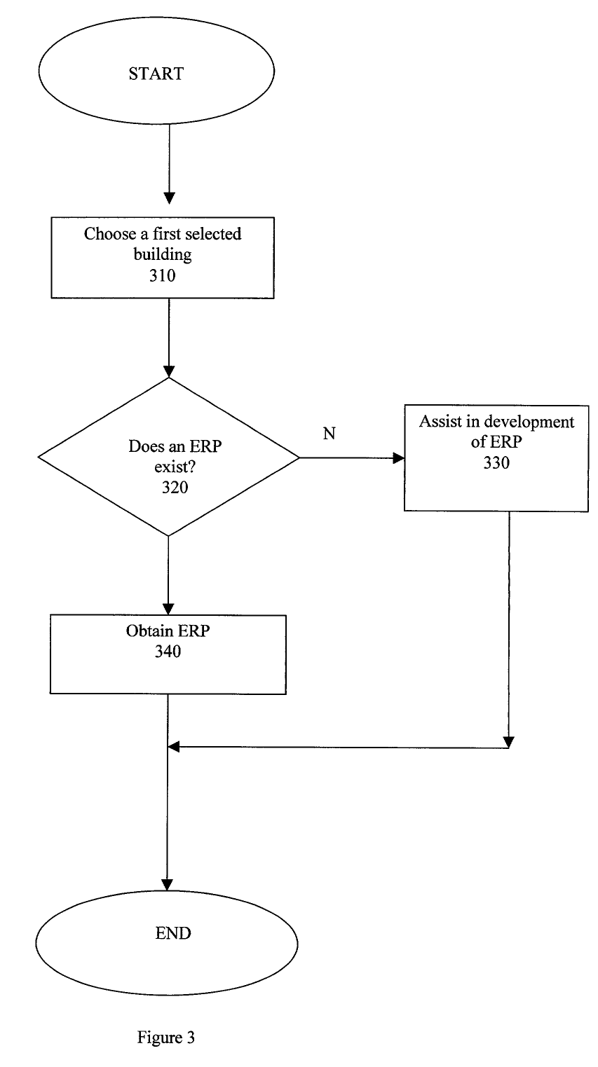

Referring to FIG. 3, at step 310 a potential building is selected. A step 320, the system inquires whether an ERP currently exists for the property. If an ERP exists, the system obtains it at step 340, otherwise the system assists in the creation development of an ERP at step 330.

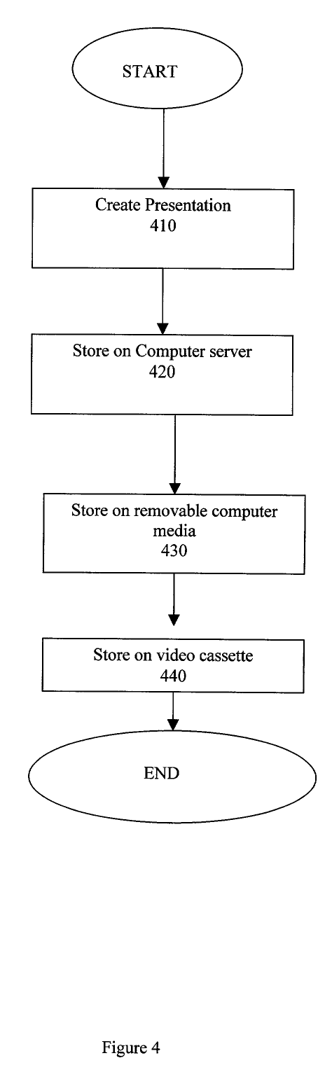

Referring to FIG. 4, at step 410 the system creates a multi-media presentation incorporating the ERP. At step 420, the presentation is stored on a computer server. Alternatively, the presentation is stored on a removable computer media such as, but not limited to, a CD-Rom or DVD-Rom. Alternatively, the presentation is stored on a videocassette.

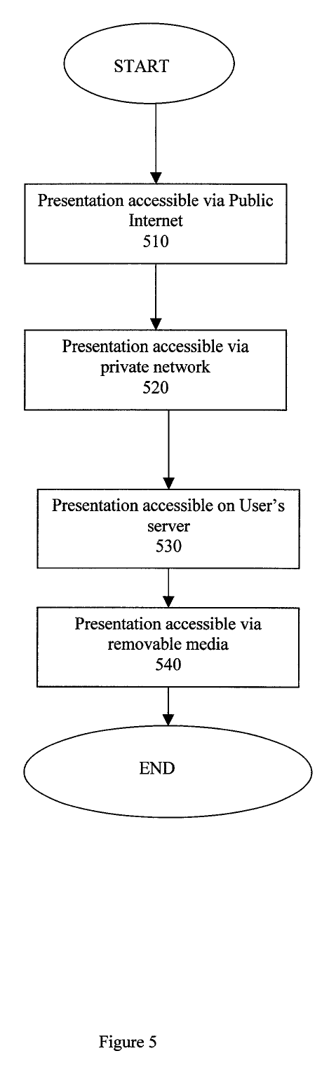

Referring to FIG. 5, at step 510, the system makes the presentation accessible over the public Internet. Alternatively, at step 520, the presentation is accessible via a virtual private network. Alternatively, at step 530 the presentation is accessible locally through the user's server.

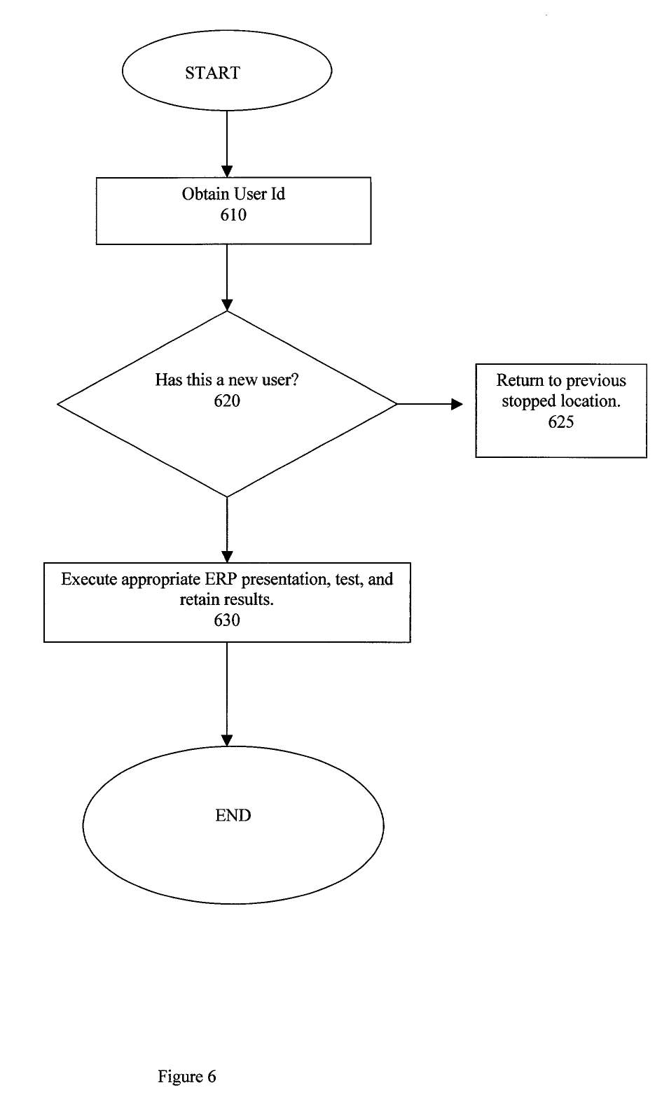

Referring to FIG. 6. At step 610, the system obtains a user Id and determines whether the user is a new user or not. If the user is a returning user, at step 625 the system continues where the user previous finished. Should the user be a new user, at step 630, the system executes the appropriate ERP presentation.

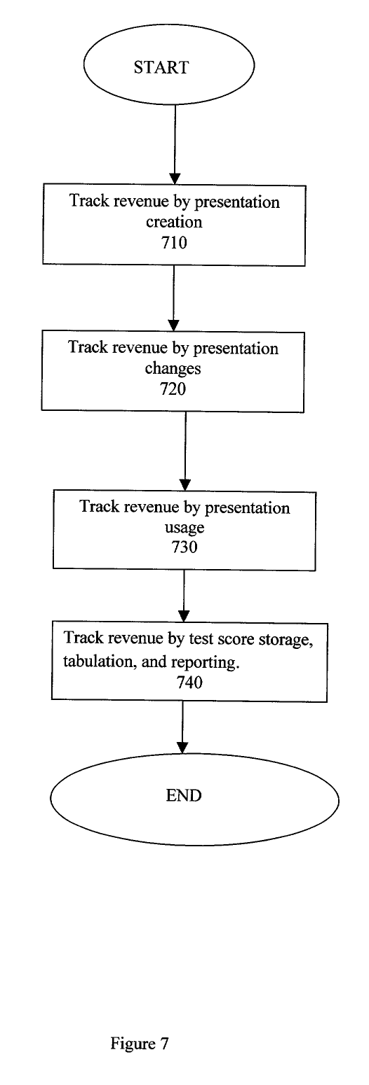

Referring to FIG. 7, at step 710 the system tracks revenue based upon cost to create the presentation. At step 720 the system tracks revenue based upon any user requested changes to the presentation. At step 730, the system tracks revenue based upon usage of the presentation. At step 740, the system tracks revenue based upon test score storage, tabulation, and reporting.

We claim:

1. A method of delivering building safety information comprising:
a. Identifying a suitable building where the deployment of building safety information can be done in an efficient, cost-effective manner;
b. Obtaining the emergency response plans;
c. Creating a customized emergency response presentation;
d. Delivering the presentation to building occupants;
e. Authenticating the users of the presentation;
f. Testing the user; and
g. Retaining the authentication data and test results.

2. The method of claim 1, step (a), where the suitable buildings are identified as Hi-rise Class A, Class B or Class C buildings.

3. The method of claim 1, step (a), where suitable buildings are identified as located in central business districts or suburban areas of major metropolitan cities.

4. The method of claim 1, step (a), where the suitable buildings are identified as having current telecommunications capabilities.

5. The method of claim 1, step (c), where the emergency response presentation is an audio-visual presentation.

6. The method of claim 5, where the audio-visual presentation is created as an interactive computerized multi-media presentation.

7. The method of claim 5, where the audio-visual presentation is created as non-interactive format.

8. The method of claim 1, step (d), where the presentation is deployed via the public Internet.

9. The method of claim 1, step (d), where the presentation is deployed over a private area network.

10. The method of claim 1, step (d), where the presentation is deployed on the customer's server.

11. The method of claim 1, step (d), where the presentation is deployed using removable media.

12. The method of claim 1, step (e), where the testing occurs after completion of the presentation.

13. The method of claim 1, step (e), where the testing occurs online.

14. The method of claim 1, step (e), where the testing occurs via telephone.

15. A system for deploying emergency response preparedness information comprising:
a. At least one server configured to host the emergency safety response multi-media presentations
b. A network configured to transmit the emergency safety response multi-media presentations
c. At least one computer connected to said network.

16. The server of claim 15 where the server can run several multi-media presentations simultaneously.

17. The server of claim 15, where the server is configured to authenticate each user, wherein said authentication is used to determine which multi-media presentation is accessed.

18. The server of claim 15, wherein the server is configured to administer an emergency response preparedness test.

19. The server in claim 18, where the server is configured to store the results of each test.

20. The server in claim 19, where the server is configured to tabulate test results.

21. The network of claim 15, step (b), where the network is the public Internet.

22. The network of claim 15, step (b), where the network is a proprietary network.

23. The computer of claim 15, step (c), where the computer is configured have access to the network of claim 15, step (b).

24. The computer of claim 15, step (c), where the computer is located at the recipient's place of business.

25. The computer of claim 15, step (c), where the computer is located in a public testing center.

26. The computer of claim 15, step (c), where the computer is located on the same private network as the server.

27. A revenue management system configured to track system usage comprising
a. A first module configured to track revenue generated from the creation of the emergency safety response presentation;
b. A second module configured to track revenue from client initiated changes to said presentation;
c. A third module configured to track system usage by clients;
d. A fourth module configured to track record keeping; and
e. A fifth module configured to summarize the record keeping information.
